(19) United States
(12) Patent Application Publication
(10) Pub. No.: US 2013/0061505 A1
(43) Pub. Date: Mar. 14, 2013

(54) PISTOL MAGAZINE LOADER

(71) Applicant: TUVIA FAIFER, MISHMAR HASHIVA (IL)

(72) Inventor: TUVIA FAIFER, MISHMAR HASHIVA (IL)

(21) Appl. No.: 13/230,862

(22) Filed: Sep. 13, 2011

(51) Int. Cl. F41A 9/83; B23P 11/00

(52) U.S. Cl. 42/87; 29/428

(57) ABSTRACT

A device for use in loading cartridges in a pistol magazine having a locking recess, the device including an ergonomic, pistol grip shaped housing including a through-going magazine receiving bore having a substantially rectangular cross-section for receiving a magazine through the bottom of the housing and enclosing the magazine therein, and an elongate bore parallel to the magazine receiving bore and extending from a top of the housing part way through the housing; a magazine catch in the housing extending into the magazine receiving bore for engaging the locking recess in the magazine; a release element, coupled to the magazine catch, for releasing the magazine catch from the magazine; and a spring loaded plunger mounted for linear movement in the elongate bore for engaging a cartridge in the magazine protruding through the magazine receiving bore.

### FIELD OF THE INVENTION

The present invention relates to devices for aiding in loading cartridges in magazines, in general and, in particular, to accessories for loading cartridges in pistol magazines.

### BACKGROUND OF THE INVENTION

Manual loading of cartridges in ammunition magazines in general, and in pistol magazines in particular, is time consuming and painful for the fingers.

There are known several devices for aiding the loading of cartridges into magazines having an open front. Since the body is open on the front side and the magazine protrudes therefrom, a user must hold both the device and the magazine, in order to retain the magazine in the body. These devices were not designed with ergonomics in mind.

There is also known from U.S. Pat. No. 5,355,606 to Origoni a device with a round housing with flanges that requires the user to grip the corners of the magazine, itself. The upper mount includes a pair of top flanges to engage the top and back of the magazine and the lower mount includes a pair of bottom flanges for engaging a middle portion of the clip. The distance between the side flanges is just slightly greater than the width of the clip so as to prevent lateral movement of the tool. With this device, a user must hold the clip or magazine inside the loader at all times while cartridges are loaded.

Many of these devices include cover elements adapted to be mounted on a magazine for manual motion relative to the magazine to depress the cartridges in the magazine and make space for an added cartridge.

There is known from U.S. Pat. No. 5,377,436 to Switzer a device that includes a sleeve of two opposing side walls and a rear wall where a magazine is inserted from the top of the device and seated on an adjustable support member. This device is adapted to receive the magazine in seated relation during reloading, and includes a handle connected to the sleeve against which the clip lies when the clip is in operational relation with the reloader. A plunger is manually reciprocable to depress a top cartridge already seated in the cartridge clip to accommodate receiving another cartridge as a successor top cartridge in the cartridge clip. An operator arm connected with the plunger is pivotally mounted to the sleeve so as to push the plunger against the uppermost cartridges while pressing the operator arm. Here too, a user must hold the magazine inside the loader at all times while cartridges are loaded in the clip, in order to prevent the clip from falling out of the loader.

The device according to U.S. Pat. No. 6,817,134 to Newman includes a complex lever with cams for rotational motion. The lever is hinged to the sleeve and the cam member is operatively engaged with the lever to provide a highly leveraged action. Squeezing the lever towards the sleeve body rotates the cam member about the cam axis which, in turn, causes an integral finger extending from the cam member to engage and depress a bullet in the magazine. A spring urges the cam member back to the relaxed position upon release of the lever. According to this method of operation, the integral finger engages the bullet at a slight angle which can cause the bullet to shift and get stuck inside the magazine. According to one embodiment, tabs are provided to engage detents on a magazine, but since the holder has no front, the user must still hold the magazine in the loader during use. Thus, in all these devices a user must hold the magazine inside the loader at all times while cartridges are loaded in the clip.

Accordingly, there is a long felt need for a relatively simple but comfortable loading device for releasable locking on a magazine, and it would be very desirable to have such a device which does not require the user to hold the magazine in the loader.

### SUMMARY OF THE INVENTION

There is provided according to the present invention a device for use in loading cartridges in a magazine, the device including a housing having the shape of a pistol grip defining therein a magazine receiving bore for receiving a magazine through the bottom of the housing, and a bore parallel to the magazine receiving bore, extending from the top of the housing and extending into the housing, a spring loaded plunger mounted in the parallel bore, and a magazine catch in the pistol grip extending into the magazine receiving bore for engaging a magazine.

According to a preferred embodiment of the invention, the pistol grip includes an ergonometric shoulder extending from the top of the grip, configured and adapted to engage and hang from a hand of a user.

Further according to the invention there is provided a method for forming a device for use in loading cartridges in a magazine, the method including providing an ergonomically shaped housing, forming a magazine receiving bore through the housing for receiving a magazine from the bottom of the housing, forming a bore parallel to the magazine receiving bore extending from the top of the housing part way through the housing, mounting a spring-loaded plunger for linear movement in the parallel bore, and providing a magazine catch in the housing extending into the magazine receiving bore for engaging a recess in a magazine.

### BRIEF DESCRIPTION OF THE DRAWINGS

The present invention will be further understood and appreciated from the following detailed description taken in conjunction with the drawings in which:

FIG. 1a is a schematic plan view illustration of a device for use in loading a magazine constructed and operative in accordance with one embodiment of the present invention;

FIG. 1b is a schematic illustration of the device of FIG. 1a with a magazine therein;

FIG. 2 is a sectional illustration of a device for use in loading a magazine according to a preferred embodiment of the invention, with a magazine therein;

FIG. 3 is a side view of the device of FIG. 2 from the direction of arrow A;

FIG. 4 is a top view of the device of FIG. 2; and

FIG. 5 is a sectional view of the device of FIG. 2 in use.

### DETAILED DESCRIPTION OF THE INVENTION

The present invention relates to devices for use in loading cartridges into pistol ammunition magazines that have a locking recess. The devices include an ergonomically shaped housing in the shape of a pistol grip having a through-going bore shaped to receive an ammunition magazine inserted through the bottom of the housing, as in a conventional pistol grip. It is a particular feature of the present invention is that the magazine receiving bore has a substantially rectangular cross section and is adapted to enclose the magazine from the front as well as the back and sides, so as to eliminate the necessity of gripping the magazine while loading cartridges therein. It is a particular feature of the invention that the housing includes a magazine catch extending into the bore, which may be substantially identical to the magazine catch in a conventional pistol, which engages the locking recess in the magazine so as to releasably lock the magazine inside the housing during loading. A releasable button or other release element provides means to facilitate the quick and easy release of the magazine catch from the magazine.

Parallel to the magazine-receiving bore is a second bore, extending from the top of the housing partially into the housing. A plunger is spring loaded in the second bore. The housing preferably includes a rounded, protruding shoulder extending from the top of the grip, which is adapted and configured to seat on and hang from a user's hand for ease of engaging the plunger while holding the device with one hand.

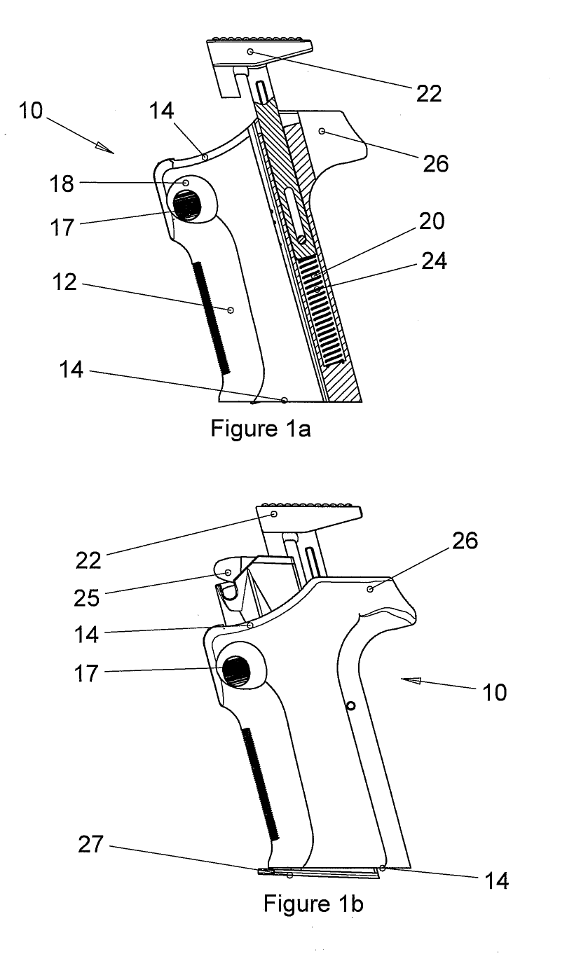

Referring now to FIG. 1, there is shown a schematic plan view illustration of a device 10 for use in loading a magazine constructed and operative in accordance with one embodiment of the present invention. Device 10 includes an ergonomically shaped housing 12 having the shape of a hand-gun handle, generally known as a pistol grip. If desired, the housing may be shaped substantially identically to the pistol whose magazine is to be loaded. Housing 12 has a through-going bore 14 for receiving a magazine from the bottom of the housing and enclosing the magazine during loading. A releasable magazine catch 18, adapted and configured to engage the locking recess in a pistol magazine, is mounted in housing 12 extending into the magazine receiving bore 14. In this way, the magazine can easily be locked in the housing and cannot fall out during loading, which is not the case in any conventional loading aids. Thus, the present device can be held during use without the user having to retain the magazine in the loader by using his or her fingers.

Housing 12 defines a second bore 20 extending from the top of the housing partially through the housing for receiving a spring loaded plunger 22 through the top. A spring 24 serves to urge plunger 22 outwards from housing 12 and away from magazine-receiving bore 14. Plunger 22 is configured to engage and press downwards a middle to rear portion of the uppermost cartridge in the magazine which protrudes upwards through the magazine receiving bore. Plunger 22 moves linearly through bore 20 to move the uppermost cartridge into the magazine and away from the top opening of bore 14, so as to permit the insertion of another cartridge into the magazine. The magazine catch 18 ensures that the magazine is in the correct location in relation to plunger 22. It will be appreciated that the linear movement of plunger 22 applies a direct pressure on a cartridge in the magazine, maintaining the alignment of the bullets inside the magazine, and no rotational force is applied to the cartridges.

Housing 12 includes a protruding shoulder 26 extending from the top of the grip, adapted and configured to seat on the hand of a user, between the thumb and the pointer, and permit easy access by the thumb of the user to the plunger 22. Thus, the loader seats on the user's hand during loading, leaving the user's fingers free. In this way, no effort need be exerted to hold onto the magazine to retain it in the loader during loading, and the user merely depresses the plunger with his thumb and inserts a cartridge with his other hand. When the magazine is full, the magazine catch is released and the magazine will slide out of the bottom of the device, in the same way it is released and slides from the grip of the pistol.

FIG. 1b is a schematic illustration of the device of FIG. 1a with a magazine 27 therein. Plunger 22 is disposed above the uppermost cartridge 25.

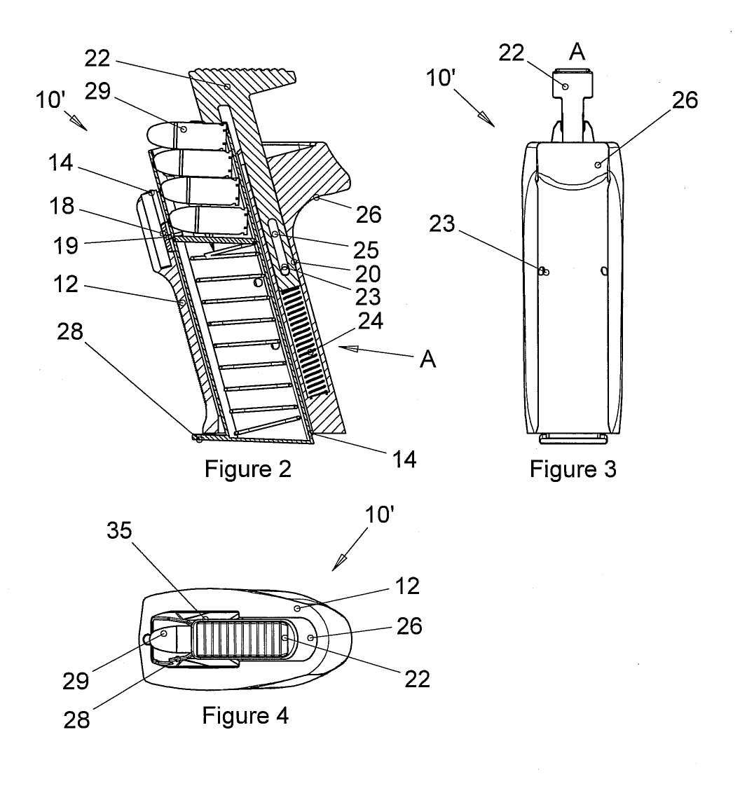

Referring now to FIGS. 2, 3 and 4, there are shown respective sectional, front and top view of a device 10′ for use in loading a magazine constructed and operative in accordance with one embodiment of the present invention, with a magazine 28 inside. Device 10′ is substantially similar to device 10 of FIG. 1 and like elements have like reference numerals. Device 10′ includes an ergonomically shaped housing 12 having the shape of a pistol grip. A magazine-receiving through-going bore 14, having a substantially rectangular cross-section, is provided in housing 12 for receiving magazine 28 through the bottom of the housing. A magazine catch 18, adapted and configured to engage a recess 19 in magazine 28, is mounted in housing 12, extending into bore 14, so as to releasably lock the magazine in the housing during loading. A button 17 or other suitable release element is provided to release magazine catch 18 from recess 19 when it is desired to remove the magazine from the housing.

Housing 12 defines a second bore 20, parallel to bore 14 but extending only part way through housing 12, for receiving a plunger 22. Plunger 22 is spring loaded through the top of the housing and biased by a spring 24, which serves to urge plunger 22 outwards from housing 12 and away from magazine-receiving bore 14. Plunger 22 moves linearly in bore 20 and is configured to engage and press downwards the uppermost cartridge 29 in the magazine so as to permit the insertion of another cartridge into the magazine. Plunger 22 preferably includes a stop member, here shown as a protruding pin 23 which extends from the plunger through a slot 25 in housing 12. As plunger 22 moves up and down, its movement is limited by the movement of pin 23 in slot 25.

Housing 12 includes a protruding shoulder 26 extending from the top of the grip and adapted and configured to seat on the hand of a user and permit easy access by the thumb of the user to the plunger 22.

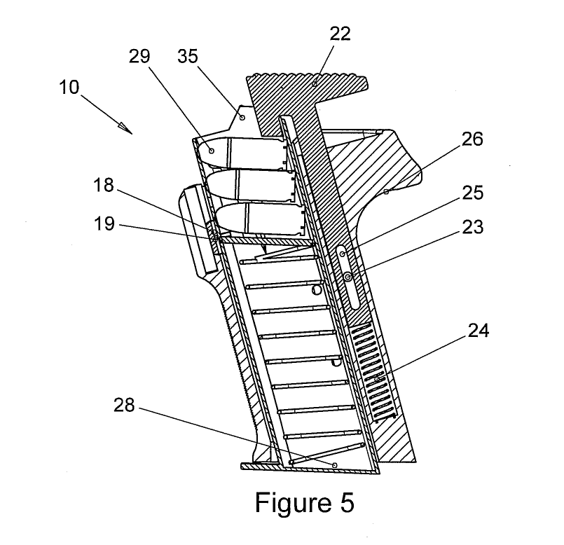

Operation of this embodiment is shown with reference to FIGS. 3 and 5. A magazine 28 to be loaded is inserted into bore 14 through the bottom of housing 12 until it clicks in place, as into a conventional grip of a pistol. In other words, the magazine is pushed into bore 14 until magazine catch 18 engages recess 19 in the magazine, thereby locking the magazine in place and enclosing the front and back of the magazine within the bore 14. Magazine catch 18 helps to ensure that magazine 28 is in the correct location in relation to plunger 22. The user grips the ergonomically shaped pistol grip housing 12, and shoulder 26 of loader 10′ hangs from the user's hand. To load a cartridge, the user merely depresses the plunger with his thumb. As shown in FIG. 5, this presses the uppermost cartridge 29 into the magazine against the action of the magazine spring and away from the top opening 35 of the magazine, thereby opening a space at the top 35 of the magazine into which a cartridge can be inserted with the user's other hand. When plunger 22 is released, spring 24 urges the plunger out of contact with the uppermost cartridge, so the added cartridge can be inserted all the way into the magazine. Further pressure on plunger 22 by the user repeats the process, with the plunger engaging the most recently added cartridge. Thus, the user can quickly and easily depress the cartridges inside the magazine to permit insertion of an additional cartridge, making loading of the magazine a much faster and less painful procedure than at present. The magazine catch 18 can be released by pressing button 17 when the magazine is full, to permit the magazine to slide downwards, out of the loader. It will be appreciated that, as plunger 22 moves up and down, its movement is limited by the stop member, here illustrated as the movement of pin 23 in slot 25.

It will be appreciated that the ergonomically designed housing, enclosing the magazine from the front side and forming a comfortable grip, allows the user to firmly hold the magazine loader without requiring him to also hold the magazine. It will further be appreciated that the housing of the magazine loader is open at the bottom and can accommodate magazines of different lengths. Thus, the structure of the device of the present invention uniquely provides the ability to operate the device solely with the use of one's hand and thumb and does not depend on the use of one's fingers to hold the magazine within the loader.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A device for use in loading cartridges in a magazine having a locking recess, the device comprising:
an ergonomic, pistol grip shaped housing including:
a through-going magazine receiving bore having a substantially rectangular cross-section for receiving a magazine through the bottom of said housing and enclosing said magazine therein, and
an elongate bore parallel to said magazine receiving bore and extending from a top of said housing part way through the housing;
a magazine catch in the housing extending into said magazine receiving bore for engaging the locking recess in the magazine;
a release element, coupled to said magazine catch, for releasing said magazine catch from said magazine; and
a spring loaded plunger mounted for linear movement in said elongate bore for engaging a cartridge in the magazine protruding through said magazine receiving bore.

2. The device according to claim 1, wherein said housing includes a protruding shoulder shaped to engage and hang from a hand of a user during use.

3. The device according to claim 1, wherein said plunger further includes a stop member to limit its motion within said housing.

4. The device according to claim 2, wherein said plunger further includes a stop member to limit its motion within said housing.

5. The device according to claim 3, wherein said housing defines a slot and said stop member includes a pin protruding from said plunger and through said slot and arranged for slideable movement along said slot.

6. The device according to claim 4, wherein said housing defines a slot and said stop member includes a pin protruding from said plunger and through said slot and arranged for slideable movement along said slot.

7. A method for forming a device for use in loading cartridges in a magazine having a locking recess, the method comprising:
providing an ergonomically shaped housing having the shape of a pistol grip;
forming a through-going magazine receiving bore having a substantially rectangular cross-section, in said housing for receiving a magazine through the bottom thereof and enclosing said magazine therein;
providing a magazine catch in said housing extending into said magazine receiving bore for engaging the locking recess in the magazine;
coupling, to said magazine catch, a release element for releasing said magazine catch from said magazine;
forming an elongate bore parallel to said magazine receiving bore from the top of said housing extending partially through said housing; and
mounting a spring-loaded plunger for linear movement in said elongate parallel bore for engaging a cartridge in said magazine protruding through said magazine engaging bore.

8. The method according to claim 7, wherein said step of providing a housing further includes forming on a top of said housing a protruding shoulder shaped to engage and hang from a hand of a user.
